(19) United States
(12) Patent Application Publication
(10) Pub. No.: US 2026/0158800 A1
(43) Pub. Date: Jun. 11, 2026

(54) METHOD OF PRINTING ON INHERENTLY WRINKLED PRINT MEDIA

(71) Applicant: CANON KABUSHIKI KAISHA, Tokyo (JP)

(72) Inventor: Marcus H.G.W. Hees, Echt (NL)

(21) Appl. No.: 19/407,676

(22) Filed: Dec. 3, 2025

(30) Foreign Application Priority Data
Dec. 6, 2024 (EP) 24218212.9

(51) Int. Cl. B41J 11/00; B41J 15/04; B41J 25/00

(52) U.S. Cl. CPC B41J 11/0085; B41J 11/0005; B41J 15/048; B41J 25/001

(57) ABSTRACT

To allow for printing on print media with pre-formed wrinkles, a printer is provided, which comprises a print applicator which prints on a portion of a print medium at a print zone; a transporter for moving the print medium with respect to the print applicator in a first direction; and a print medium suction applicator comprising: a plurality of suction chambers, wherein at least one suction chamber faces a print zone, and at least one other suction chamber is arranged upstream and/or downstream of the suction chamber facing the print zone in the first direction, characterized in that the print medium suction applicator further comprises a suction reduction unit configured to selectively prevent or reduce suction in the at least one other suction chamber.

### CROSS-REFERENCE TO RELATED APPLICATIONS

This application claims priority to European Patent Application No. 24218212.9 filed on Dec. 6, 2024, which is incorporated by reference herein in its entirety.

### BACKGROUND

### Field of the Disclosure

The disclosure relates to a printer and a method of printing.

### Description of Background Art

Wrinkles in print media may result in visible print artifacts after printing thereon. Certain print media, especially when supplied in roll form, may have been processed, so that these print media contain pre-formed wrinkles. The pre-formed wrinkles may have been formed during the manufacturing process or while winding the print media into roll form. These media are herein referred to as inherently wrinkled print media. In absence of external forces, the print media return to their wrinkled state. It is noted that other types of wrinkles may also be introduced into print media while being handled by the printer, e.g. by locally folding or bending. The occurrence of these latter wrinkles in the printer can be prevented by careful handling of the media. It is for example known that suction may be applied to print media to flatten the print media against a medium support surface while printing. Here, the problem relates to pre-formed wrinkles that have been pre-formed into the print medium, so that these are present in the material as it is supplied to the printer. Known methods and configurations of applying suction do appear to fully allow for high quality printing on inherently wrinkled print media. Suction, as in known systems, applied to a pre-formed wrinkle that was inherently present in a print medium, fails to sufficiently reduce or remove said pre-formed wrinkle.

### SUMMARY OF THE DISCLOSURE

The present disclosure is directed to provide an improved method of printing, specifically one which allows for reliably printing on inherently wrinkled print media as well as on other types of media.

In accordance with the present disclosure, a printer and a method are provided.

The printer comprises: a print applicator configured to print on a portion of a print medium at a print zone; a transporter configured to move the print medium with respect to the print applicator in a first direction; and a print medium suction applicator comprising a plurality of suction chambers, wherein at least one suction chamber of the plurality of suction chambers faces the print zone, and at least one other suction chamber of the plurality of suction chambers is arranged upstream and/or downstream of the print zone facing suction chamber in the first direction. The printer is characterized in that the print medium suction applicator further comprises a suction reduction unit configured to selectively prevent or reduce suction in the at least one other suction chamber.

It is the insight of the inventor to re-locate pre-formed wrinkles in inherently wrinkled print media to portions of the print medium outside of the print zone, so that the print medium is locally and temporarily de-wrinkled and the print medium is allowed to re-assume its wrinkled state outside of the print zone. It is the further insight of the inventor that pre-formed wrinkles can be moved out of the print zone by applying suction in the print zone, while allowing the print medium to move with respect to its print medium support surface in an area neighboring the print zone. The latter may be achieved by applying no or little suction to a portion of the print medium adjacent the print zone.

The print applicator has a limited working area, which is located in the print zone. The transporter moves the print medium through the print zone, so that an image is printed on it by the print applicator. The suction chamber assembly comprises at least two suction chambers separated from one another in the transport direction. A first suction chamber is positioned at the print zone, so that a negative pressure can be applied to a portion of the print medium in the print zone via this first suction chamber. It will be appreciated that the print zone may comprise additional suction chambers as well. Thereby, the print medium is flattened in the print zone. A second suction chamber is adjacent the first suction chamber as well as upstream and/or downstream of the first suction chamber. The negative pressure in the second suction chamber can be substantially decreased or removed by means of the suction reduction unit. Then, the pressure in the second suction chamber is close to atmospheric, allowing relative movement between the print medium and the print medium support surface over the second suction chamber. When then, a negative pressure is applied to the first suction chamber, any pre-formed wrinkles in the print medium over the first suction chamber are driven towards and over the second suction chamber, since there the print medium is free to move with respect to the print medium support surface. When moving the print medium in the transport direction, this configuration ensures that the portion of the print medium in the print zone is substantially wrinkle-free (or at least significantly reduced in pre-formed wrinkles) due to the negative pressure applied to the print zone. Pre-formed wrinkles that were inherently present in the supplied print media are thus temporarily driven out of the print zone to the buffer zone, and allowed to return to their original position outside of the buffer zone.

When an inherently wrinkle-free print medium is applied, the suction reduction unit may be applied to apply suction in the at least one other suction chamber to reliably hold such a print medium onto the print medium support surface. Thus, an inherently wrinkle-free and inherently wrinkled print media can be reliably printed on the same printer.

More specific optional features of the disclosure are indicated in the dependent claims.

In an embodiment, the printer further comprises a controller configured to control the printer: in an inherently wrinkled medium print mode, wherein the controller controls the suction reduction unit, so that substantially no suction is applied to the print medium when over the at least one other suction chamber; and in a wrinkle-free medium print mode, wherein the controller controls the suction reduction unit, so that suction is applied to the print medium when over the at least one other suction chamber.

The printer has two print modes to handle a wide variety of different print media. When inherently wrinkled print media are applied, the at least one other suction chamber is kept at or near atmospheric pressure. In contrast, when in the wrinkle-free medium print mode, a negative pressure is applied in the at least one other suction chamber. In both print modes, a negative pressure is applied in the suction chamber facing the print zone. In the wrinkle-free medium print mode, the negative pressure ensures that the print medium is held onto the print medium support surface over the suction chamber facing the print zone and the at least one other suction chamber. Over all said suction chambers, the print medium is drawn and held against the print medium support surface. In the inherently wrinkled medium print mode, the print medium is not actively drawn against the print medium support surface over the at least one other suction chamber by means of suction, in contrast to over the print zone facing suction chamber, where the print medium is actively drawn against the print medium support surface.

In an embodiment, a negative pressure in the at least one other suction chamber is substantially closer to atmospheric pressure than a negative pressure in the suction chamber facing the print zone. The pressure in the at least one other suction chamber is preferably no greater than 50% of the pressure in the suction chamber facing the print zone in absolute terms, very preferably not greater than 25%, even more preferably at least 10%. In another embodiment, the at least one other suction chamber is (directly) neighboring and/or adjacent the suction chamber facing the print zone. A distance between the at least one other suction chamber and the suction chamber facing the print zone is preferably not greater than 10 cm, very preferably not greater than 5 cm, even more preferably not greater than 2 cm, and extremely preferably not greater than 1 cm.

In an embodiment, the transporter further comprises an endless belt provided with passages through which sufficient suction can be applied to the print medium via at least one of the suction chambers of the print medium suction applicator, so that the print medium moves with the belt. The belt is movable over the suction chambers by means of a drive. The surface of the belt facing the print applicator forms the print medium support surface. The belt may be formed of any suitable material, preferably a sheet material, such as plastic, metals, etc. The passage may be formed by any suitable methods, such punching, drilling, cutting, etc. Also, belt materials formed with intrinsic passages, such as mesh belts may be applied.

In an embodiment, the at least one other suction chamber comprises an upstream and a downstream suction chamber positioned adjacent the suction chamber facing the print zone, and wherein the suction reduction unit is configured to adjust the suction in said upstream and downstream suction chambers. Two suction chambers are connected to the suction reducing unit, one such suction chamber adjacent and upstream of the suction chamber facing the print zone and another suction chamber neighboring to and downstream of the suction chamber facing the print zone. In the inherently wrinkled media print mode, substantially atmospheric pressure is applied in these two suction chambers, so that pre-formed wrinkles can be forced out of the print zone into a buffer zone defined by either of these two suction chambers. The negative pressure applied to the print zone drives the pre-formed wrinkles into the buffer zones. The suction reduction unit is connected to the upstream and downstream suction chambers, so that these can adjust the pressure therein to or near atmospheric pressure, for example by preventing suction to the upstream and downstream suction chambers or by openings these suction chambers to the ambient with sufficient flow to overcome any suction. In another example, the suction reduction unit may close off a side of these suction chambers facing the print medium.

In an embodiment, the print medium suction applicator further comprises driving suction chambers positioned respectively upstream of the upstream suction chamber and downstream of the downstream suction chamber, wherein the suction chamber assembly is configured to exert a greater negative pressure in the driving suction chambers than in the suction chamber facing the print zone and greater than in the upstream and downstream suction chambers. To move the print medium by means of the belt, sufficient friction between the belt and the print medium is required. This is achieved by applying sufficiently large negative pressure to the print medium to draw it against the belt. The driving zones are defined by suction chambers separate from those suction chamber defining the print zone and the buffer zones. This allows a relatively large negative pressure to be locally applied in the driving zones. The pressure in the print zone and optionally the buffer zones can then be kept relatively small to prevent excess friction between the belt and its support.

In an embodiment, the transporter further comprises a drive for moving the belt in the first direction. The drive preferably moves the print medium in steps past the print applicator.

In an embodiment, in the inherently wrinkled medium print mode, the controller controls the print medium suction applicator to apply a negative pressure in the suction chamber facing the print zone, so that a portion of the print medium is locally flattened and any pre-formed wrinkles in said portion are moved into a buffer zone, wherein the suction reduction unit has reduced or prevented suction. The buffer zone is defined by the suction chamber(s) connected to the suction reduction unit. The buffer zone is preferably directly adjacent the print zone in the transport direction.

In an embodiment, the printer further comprises an input roller for supporting a roll of wound-up print medium. The printer is a roll printer, preferably a roll-to-roll, wherein print media are unwound from an input roller, printed on, and re-wound on an output roller.

In an embodiment, the buffer zones defining suction chambers, and preferably the suction chamber facing the print zone, are connected to a first suction source for applying a relatively smaller negative pressure, and the driving zone defining suction chambers are connected to a second suction source for applying a relatively larger negative pressure.

The present invention further relates a printer comprising: a print applicator comprising at least one printhead arranged to define a print zone, wherein the at least one printhead is configured to print on a portion of a print medium in the print zone; a transporter configured to move the print medium through the print zone with respect to the print applicator in a first direction; and a print medium suction applicator comprising a plurality of suction chambers, wherein at least one suction chamber faces the print zone, and wherein at least one other suction chamber is arranged upstream and/or downstream of the suction chamber facing the print zone in the first direction, and wherein the print medium suction applicator further comprises a suction reduction unit configured to selectively prevent or reduce suction in the at least one other suction chamber. Preferably, the transporter comprises and endless belt, and wherein the print zone spans a substantially full width of the belt in a lateral direction perpendicular to the transport direction. The at least one other suction chamber may be positioned outside of the print zone when viewed in a height direction perpendicular to the transport and lateral directions. In addition, the at least one suction chamber may be positioned within the print zone when viewed in a height direction perpendicular to the transport and lateral directions.

The present invention further relates to a method for printing on an inherently wrinkled print medium with pre-formed wrinkles, the method comprising the steps of: transporting the inherently wrinkled print medium through a print zone facing a print applicator; applying suction to the inherently wrinkled print medium in the print zone; and preventing suction in at least one buffer zone adjacent to and upstream and/or downstream of the print zone, so that the inherently wrinkled print medium is locally flattened in the print zone, forcing pre-formed wrinkles into the at least one buffer zone.

The print medium moves along the print applicator through the print zone. In the print zone, suction is applied to the side of the print medium facing the suction chamber defining the print zone. Thereby, the print medium is locally flattened in the print zone. When the print medium is flattened in the print zone, any pre-formed wrinkle previously in the print zone are driven in or against the transport direction into the buffer zone. In each buffer zone, no or ineffectively little suction is applied to the print medium, so that the print medium can deform away from the print medium support surface to take-up the pre-formed wrinkles from the print zone. This allows for printing on inherently wrinkled print media. When printing on inherently wrinkle-free print media, suction may be applied in the buffer zone to ensure reliable holding down of the print media to prevent the formation of a different type of pre-formed wrinkles, namely pre-formed wrinkles introduced into the print medium by its handling or transport in the printer.

In an embodiment, the method further comprises the steps of: transporting a wrinkle-free print medium through the print zone; applying suction to the wrinkle-free print medium in the print zone; and applying suction in at least one buffer zone, so that the wrinkle-free print medium is locally flattened in the print zone and the at least one buffer zone.

The printer is able to operate to switch between two print modes, one for inherently wrinkled print media and one for print media which are inherently free of such pre-formed wrinkles. It will be appreciated that inherent, pre-formed wrinkles refer to pre-formed wrinkles that are present in the print media as it is supplied and loaded into the printer. Non-inherent wrinkles may be introduced into either type of media by handling the print medium. For inherently wrinkle-free print media, suction is applied in the buffer zone(s) by applying a negative pressure in the buffer zone defining suction chamber(s).

In an embodiment, the step of transporting further comprises: moving a belt, wherein suction is applied to the print respective medium via passages in the belt, and applying greater suction to the respective print medium in at least one driving zone as compared to the print zones and the at least one buffer zone, wherein a buffer zone is positioned between its adjacent driving zone and the print zone.

The print media are held onto the belt by means of a negative pressure applied via the passages in the belt. The negative pressure applied in print zone (and the buffer zones in the inherently wrinkle-free medium print mode) is sufficient to flatten the print medium there against the belt. However, a relatively large negative is preferred to ensure that the print medium does not slip over the belt. Thereto, one or more driving zones have been provided preferably on opposite sides of the buffer zones with respect to the print zone. In the driving zone a relatively large negative pressure can be locally applied. Preferably, the driving zones are positioned adjacent rollers supporting the belt. Suction herein is defined as scaling with negatived pressure.

In an embodiment, a buffer zone and/or a driving zone is provided on both an upstream and a downstream side of the print zone.

In an embodiment, both buffer zones are connected to a first, suction source and/or both driving zones are connected to a second suction source. The buffer zone defining suction chambers, and preferably the print zone facing suction chamber are connected to first suction source. The first suction source is preferably a “high flow” pump configured to transport a relatively large volume of air per unit time, but limited in its pressure reducing capacity. Thus, the negative pressure applied to the print zones, and optionally the buffer zones, is relatively small. The buffer zones are preferably connected to the first suction source via the suction reducing means. The driving zones are connected to a second suction source. The second suction source is configured to achieve a relatively large negative pressure, though its flow capacity may be limited.

Further scope of applicability of the present disclosure will become apparent from the detailed description given hereinafter. However, it should be understood that the detailed description and specific examples, while indicating preferred embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure, and wherein:

FIG. 1 is a schematic, cross-sectional view of a printer according to the present disclosure;

FIG. 2 is a schematic, cross-sectional view of the printer in FIG. 1 in an inherently wrinkle-free medium print mode;

FIG. 3 is a graph representing the pressure profile applied to the printer in FIG. 2;

FIG. 4 is a schematic, cross-sectional view of the printer in FIG. 1 in an inherently wrinkled medium print mode;

FIG. 5 is a graph representing the pressure profile applied to the printer in FIG. 4;

FIG. 6 is a first schematic cross-sectional view of a pre-formed wrinkle in an inherently wrinkled print medium moving from a buffer zone to a print zone in the printer in FIG. 4;

FIG. 7 is a second schematic cross-sectional view of a pre-formed wrinkle in an inherently wrinkled print medium moving from a buffer zone to a print zone in the printer in FIG. 4; and

FIG. 8 is a schematic, top-down view of the printer in FIG. 1; and

FIG. 9 is a diagram illustrating a method of printing according to the present disclosure.

### DETAILED DESCRIPTION OF THE EMBODIMENTS

The present disclosure will now be described with reference to the accompanying drawings, wherein the same reference numerals have been used to identify the same or similar elements throughout the several views.

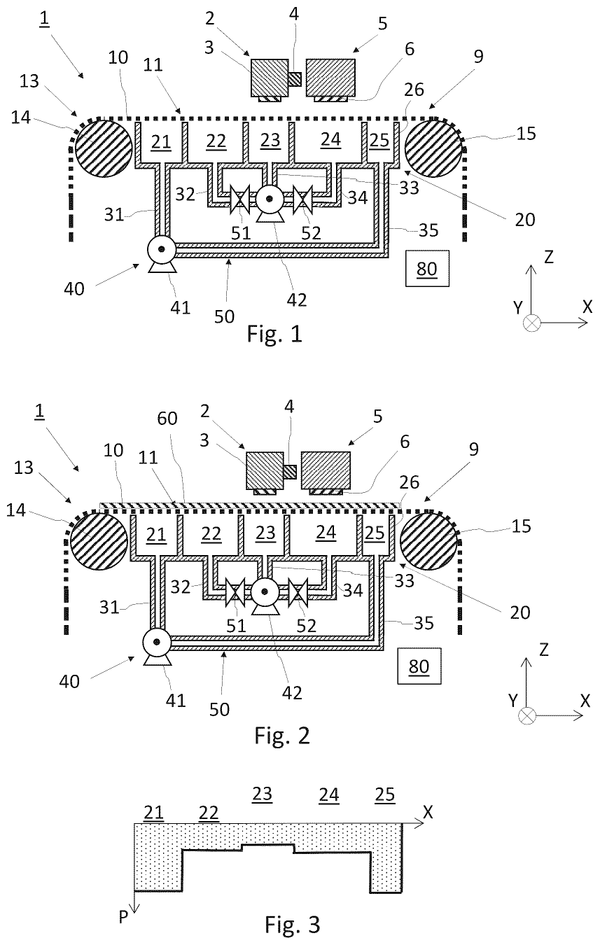

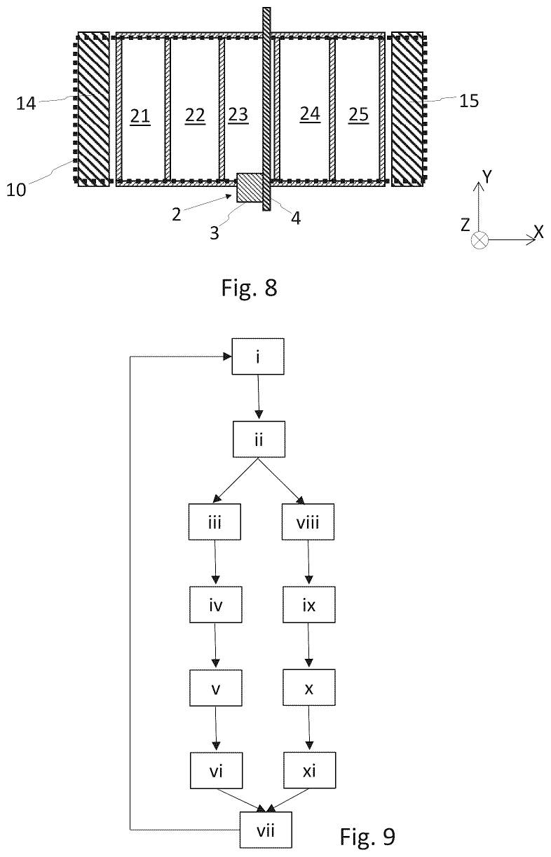

FIG. 1 schematically illustrates a cross-section of a scanning inkjet printer 1, which is also shown top-down in FIG. 8. The printer 1 includes a print applicator 2 formed by a printhead carriage 3, which is arranged to reciprocally move along a gantry 4 in the width direction Y. The print applicator 2 prints on a portion of a print medium 60, 70 at a print zone. The printhead carriage 3 may be provided with one or more printheads for jetting droplets of ink. The printheads may be any suitable type of printhead, e.g. piezo-actuated printheads, thermal printheads, bubblejet print heads, etc. Other suitable print assemblies may be applied as well. Downstream of the print applicator 2, a fixation station 5 may optionally be provided to fixate the printed material onto the print medium. The fixation station 5 may include an emitter for emitting heat or (UV) light towards the print medium to trigger or accelerate the hardening of the print material onto the print medium.

The print medium moves past the print applicator 2 in the transport direction X by means of a transporter 13. The transporter 13 includes an endless belt 10. The belt 10 is provided with passages 11 that allow air to pass through the belt 10. The passages 11 may be openings, through-holes, or other suitable types of passages 11. The belt 10 is preferably a single belt 10 spanning at least the working area width of the print applicator 2. The belt 10 is supported on rollers 14, 15. At least one of the rollers 14, 15 is provided with a drive (not shown) for moving the belt 10. Preferably, the belt 10 is moved step-wise in between scans of the printhead carriage 3, but continuous movement may also be applied.

The belt 10 extends over a print medium suction applicator 20 formed by a plurality of suction chambers 21-25. The suction chambers 21-25 are positioned in a row in the transport direction X. Each suction chamber 21-25 is separated from its neighbor by a separation wall, so that the negative pressure therein can be set different from its neighbor. The suction chambers 21-25 are open at their top side, where these support the belt 10. By applying a negative pressure in a suction chamber 21-25, a print medium can be locally drawn against the portion of the belt 10 over the respective suction chamber 21-25. The transporter (13) includes the print medium suction applicator (20). The print medium suction applicator 20 may be formed of any suitable material, such as metal, plastic, etc.

The central suction chamber 23 faces the print applicator 2. The central suction chamber 23 defines the print zone. Neighboring the print zone facing suction chamber 23 in the transport direction X are the buffer zones defining suction chambers 22, 24. Ahead of the upstream buffer zone defining suction chamber 22 in the transport direction X is a driving zone defining suction chamber 21. Similarly, another driving zone defining suction chamber 25 is positioned neighboring to and downstream of the downstream buffer zone defining suction chamber 24. It will be appreciated that suction chambers 21-25 with similar names will have similar functions and that any number of such suction chambers 21-25 suffices to achieve the respective function. While two suction chambers 22, 24-25 for the driving zones and the buffer zones are shown in the example in FIG. 1, a single suction chamber for each type of zone will also suffice. More suction chambers 21-25 for each type of zone may also be applied.

The negative pressure is applied by means of a suction source assembly 40. The suction source assembly 40 in FIG. 1 includes a first suction source 41 connectable to the print zone facing suction chamber 23 and the buffer zone defining suction chambers 22, 24 via the respective lines 32-34. The lines 32, 34 between the suction source 42 and respectively the buffer zone defining suction chambers 22, 24 are provided with suction reduction units 51, 52 as part of a suction zone selection system 50. The suction reduction units 52, 53 are in a first state configured to substantially prevent suction in the respective buffer zone defining suction chamber 22, 24, so that the pressure in said suction chamber 22, 24 is at or close to atmospheric pressure. In the first state, the suction source 42 still applies a substantial negative pressure to the print zone facing suction chamber 23, so that print media are drawn against the belt 10 over said suction chamber 23. In a second state, the suction reduction units 51, 52 connect the suction source 42 to the buffer zone defining suction chambers 22, 24. In the second state, the suction source 42 applies a substantial negative pressure to the buffer zone defining suction chambers 22, 24, preferably comparable to what is applied to the print zone facing suction chamber 23. The print medium is then locally drawn against the belt 10 over the buffer zone defining suction chambers 22, 24 as well as over the print zone facing suction chamber 23. The suction source 42 may be any suitable suction device, such as a fan or pump. While in FIG. 1, a single suction source 42 is provided for multiple suction chambers 22-24, each suction chamber 21-25 may be applied with its own respective suction source 42. The suction reduction units 51, 52 are indicated in FIG. 1 as controllable valves, but may include any suitable form of pressure control means. Alternative to valves, the suction reduction units 51, 52 may adjust the suction by controlling the operational level or power of the suction source 42.

The driving zone defining pressure chambers 21, 25 are connected to the second suction source 41 via lines 31 and 35. The second suction source 41 is preferably configured to apply a greater negative pressure than the first suction source 42. The greater negative pressure in the driving zone defining suction chambers 21, 25 ensures that near the rollers 14, 15, the print medium is securely held onto the belt 10 for reliable transport.

A controller 80 is provided connected to the transporter 13, the print applicator 2, and the fixation station 5. In particular, the controller 80 controls the suction reduction units 51, 52 to switch between their first and second states, when the controller 80 operates in respectively an inherently wrinkled print mode and an inherently wrinkle-free medium print mode. In both modes, the second suction source 41 is controlled to apply a relatively great negative pressure to the driving zone defining suction chambers 21, 25. In both modes, the controller 80 controls the suction zone selection system 50, so that the first suction source 42 applies a negative pressure smaller than that in the driving zone defining suction chambers 21, 25 in the print zone facing suction chamber 23. While the negative pressure in the print zone facing suction chamber 23 is less (in absolute terms) than that in the driving zone defining suction chambers 21, 25, this negative pressure in the central suction chamber 23 is still sufficient to locally flatten a print medium 60, 70 against the belt 10. The controller 80 in the inherently wrinkled print mode controls the suction zone selection system 50, so that the suction reduction units 51, 52 are in their first state. In the first state, lines 32, 34 are effectively blocked, preventing the first suction source 42 from reducing the pressure in the buffer zone defining suction chambers 22, 24. In the inherently wrinkled print mode, the pressure in the buffer zone defining suction chambers 22, 24 is close to or at atmospheric pressure. In consequence, the print medium over the buffer zone defining suction chambers 22, 24 is not drawn against the belt 10. Locally the print medium over the buffer zone defining suction chambers 22, 24 is allowed to move with respect to the belt 10, allowing the print medium there to deform, to e.g. take-up pre-formed wrinkles from portions of the print medium in the print zone.

In the inherently wrinkle-free medium print mode, the controller 80 controls the suction reduction units 51, 52 to be in their second state. Lines 32, 34 are then connected to the first suction source 42 and a negative pressure is applied to the buffer zone defining suction chambers 22, 24. This negative pressure is preferably similar or comparable to that in the print zone facing suction chamber 23. In consequence, in the inherently wrinkle-free medium print mode, the print medium is locally drawn against the belt 10 over the buffer zone defining suction chambers 22, 24.

FIG. 2 illustrates the printer of FIG. 1 operating in the inherently wrinkle-free medium print mode. Note that for the sake of illustration only, the upper portion of the print medium 60 is shown. The print medium 60 has been processed, so that it was provided in e.g. roll form free of pre-formed wrinkles. When unwinding such a print medium from the roll, no pre-formed wrinkles are present, unless introduced via the handling of the print medium after unwinding.

In FIG. 2, the wrinkle-free print medium 60 is loaded onto the belt 10, and any pre-formed wrinkles introduced during loading can be removed spooling the pre-formed wrinkles sections of the print medium 60 of the belt 10. During continued operation, the print medium 60 is provided in wrinkle-free form, as it is spooled of an input roller onto belt 10. In the inherently wrinkle-free medium print mode, the pressure profile as shown in FIG. 3 is applied. The second suction source 42 provides a relatively large, gripping pressure to the print medium 60 in the driving zone defining suction chambers 21, 25. In between said suction chambers 21, 25, a relatively smaller, negative pressure is applied in the in between suction chambers 22-24. This reduces the friction between the belt 10 and its support. The in between suction chambers 22-24 are in connection to the first suction source 42. In consequence, the print medium 60 is securely held and flattened over all suction chambers 21-25.

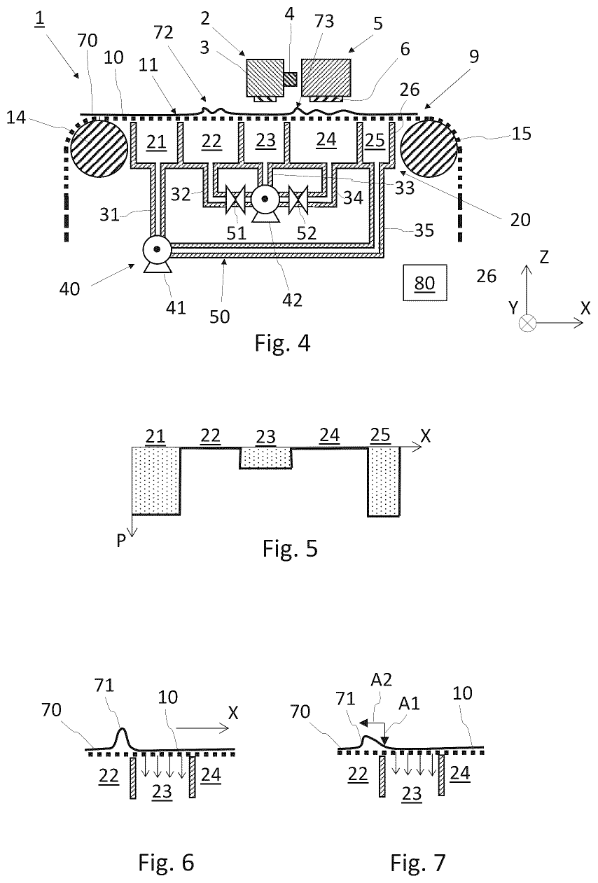

In FIG. 4, an inherently wrinkled print medium 70 is loaded onto the belt 10. Inherently wrinkled is herein defined as a print medium 70 that is supplied or processed to contain pre-formed wrinkles. The pre-formed wrinkles are present in the print medium 70 when it is provided in roll form on the input roller of the printer 1. The pre-formed wrinkles are processed into the print medium 70 and generally can only be temporarily removed from the print medium. In absence of flattening forces, the print medium 70 returns to its wrinkled state.

The print medium 70 is loaded onto the belt 10. In the inherently wrinkled medium print mode, the pressure profile as shown in FIG. 5 is applied. Similar to FIGS. 2 and 3, the second suction source 42 provides a relatively large, gripping pressure to the print medium 70 in the driving zone defining suction chambers 21, 25. In the central suction chambers 23 a relatively smaller, negative pressure is applied via the first suction source 42. The suction reduction units 51, 52 are in their first state, so that the buffer zone defining suction chambers 22, 24 are at atmospheric pressure. In consequence, the print medium 70 is free to move with respect to the belt 10 over the buffer zone defining suction chambers 22, 24. This allows the negative pressure in the print zone to flatten the print medium 70 over the central suction chamber 23. Therein pre-formed wrinkles are driven towards the buffer zones in the transport direction X.

FIGS. 6 and 7 schematically illustrate the de-wrinkling of the print medium 70 in the print zone. In FIG. 10, the print medium 70 has a pre-formed wrinkle 71. Initially, the print medium 70 was loaded onto the belt 10, so that the pre-formed wrinkle 71 was over the central suction chamber 23. The negative pressure was then applied to the central suction chamber 23, so that the print medium 70 was locally flattened over the central suction chamber 23. This causes the pre-formed wrinkle to move into a buffer zone over the neighboring suction chamber 22 adjacent the central suction chamber 23. Since no suction was applied in suction chamber 22, the print medium 70 was free there to deform, so that it could take-up the pre-formed wrinkle 71. During operation, the belt 10 is moved, so that the print medium 70 is moved in the transport direction X. The pre-formed wrinkle 71 therein also experiences a forward force driving it back towards the central suction chamber 23. However, the absence of suction in the suction chamber 22 combined with the negative pressure in the central suction chamber 23 maintains the pre-formed wrinkle 71 over the left suction chamber 22. When the pre-formed wrinkle 71 moves over the suction chamber 23, the material from the pre-formed wrinkle 71 is sucked against the belt 10. This flattens the print medium 70 against the belt 10, as it moves over the central suction chamber 23. This downward pulling (indicated by arrow A1) of the pre-formed wrinkle 71 causes an opposing force (indicated by arrow A2) on the material forming the pre-formed wrinkle 71 opposite to the transport direction X. Effectively, as the pre-formed wrinkle 71 is pulled down at the upstream edge of the central suction chamber 23, it forces its material in the wrinkle in a direction opposite the transport direction X. Since no suction is applied in the left suction chamber 22, the print medium 70 there is free to deform to take-up the excess material by allowing the print medium 70 to locally lift away from the belt 10. In consequence, the pre-formed wrinkle 71 is dynamically held in place upstream of the central suction chamber 23. The transition from no suction in the left suction chamber 22 to suction in the central suction chamber 23 effectively ‘irons’ the pre-formed wrinkle against the transport direction X of the belt 10. It will be appreciated that similar effects occur mutatis mutandis at the right suction chamber 24 in FIG. 4. When the respective portion with the pre-formed wrinkle 71 has passed the suction chamber 23, that portion is allowed to re-assume its pre-formed wrinkle 71.

FIG. 9 illustrates the steps of a method of printing. In step i, a print job is submitted to the printer 1. In step ii, the print mode corresponding to the received print job is determined. Step ii determines whether the printer 1 will operate in the inherently wrinkled medium print mode or the inherently wrinkle-free medium print mode. This selection may be input manually by an operator or be determined by the printer's controller, for example based on the media type prescribed or selected for the respective print job. The controller may store a media catalogue, wherein the respective print modes are assigned to the different media types, e.g. in the form of a look-up table. In the examples in FIGS. 1 to 8, the inherently wrinkled medium print mode is applied when the printer operates in a roll-to-roll mode.

In step iii, the printer 1 is set to run in the inherently wrinkled medium print mode. After the print medium 70 has been loaded, negative pressures are applied to the outer most suction chambers 21, 25 and the print zone facing suction chamber 23 in step iv. No or very little negative pressure is applied to the suction chambers 22, 24 next to the print zone facing suction chamber 23. The negative pressures in the outer suction chambers 21, 25 are larger than that in the print zone facing suction chamber 23.

This, in step v, results in the print medium 70 being locally flattened in the print zone over the print zone facing suction chamber 23. Wrinkles 72 are thereby driven out of the print zone over the upstream and/or downstream suction chambers 22, 24. The print medium 70 is relatively loosely held against the belt 10 over the upstream and/or downstream suction chambers 22, 24. That allows the print medium 70 there to locally move away from the belt 10, so that it can temporarily take up wrinkles from the print zone. In step vi, the print medium 70 is transported in the transport direction X. Therein wrinkles 72 can be fed towards the print zone, but are in the print zone flattened, wherein wrinkles are effectively driven to the upstream and/or downstream suction chambers 22, 24, as in step v. This is repeated until the print job has been completed in step vii. A new print medium 70 may then be loaded and the process may be repeated.

In case in step i it is determined that the printer is to operate in the inherently wrinkle-free medium print mode in step viii. In this case, all suction chambers 21-25 are controlled to apply a substantial negative pressure, so that over each suction chamber 21-15 the print medium 60 is locally held onto the belt 10 in step ix. Therein, in the outer most suction chambers 21, 25 near the rollers 14, 15, the negative pressure is preferably greater (in absolute terms) than that applied to the in between suction chambers 22-24. The suction chambers 22-24 preferably apply a relatively small negative pressure, but are arranged to handle a relatively large air flow (e.g. in terms of volume per area per unit time). This pressure may be the same or similar for said suction chambers 22-24. In step x, over all suction chambers 21-25 the print medium 60 is locally held onto the belt 10. In this manner the print medium 60 in step xi is transported until the completion of the print job in step vii. From there, the process may be repeated from step i.

Although specific embodiments of the disclosure are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present disclosure being thus described, it will be obvious that the same may be varied in many ways. Such variations are not to be regarded as a departure from the spirit and scope of the present disclosure, and all such modifications as would be obvious to one skilled in the art are intended to be included within the scope of the following claims.

1. A printer comprising:
a print applicator configured to print on a portion of a print medium at a print zone;
a transporter f configured to move the print medium with respect to the print applicator in a first direction; and
a print medium suction applicator comprising a plurality of suction chambers,
wherein at least one suction chamber of the plurality of suction chambers faces the print zone, and
wherein at least one other suction chamber of the plurality of suction chambers is arranged upstream and/or downstream of the print zone facing suction chamber in the first direction, and
wherein the print medium suction applicator comprises a suction reduction unit configured to selectively prevent or reduce suction in the at least one other suction chamber.

2. The printer according to claim 1, further comprising a controller configured to control the printer,
wherein in an inherently wrinkled medium print mode, the controller controls the suction reduction unit, so that substantially no suction is applied to the print medium when the print medium is over the at least one other suction chamber, and
wherein in a wrinkle-free medium print mode, the controller controls the suction reduction unit, so that suction is applied to the print medium when the print medium is over the at least one other suction chamber.

3. The printer according to claim 2, wherein the transporter comprises an endless belt provided with passages through which sufficient suction can be applied to the print medium via at least one of the suction chambers, so that the print medium moves with the belt.

4. The printer according to claim 3, wherein the at least one other suction chamber comprises upstream and downstream suction chambers positioned adjacent to the suction chamber of the plurality of suction chambers that faces the print zone, and wherein the suction reduction unit are configured to adjust the suction in the upstream and downstream suction chambers.

5. The printer according to claim 4, wherein the plurality of suction chambers comprises driving suction chambers positioned respectively upstream of the upstream suction chamber and downstream of the downstream suction chamber, wherein the suction chamber assembly is configured to exert a greater negative pressure in the driving suction chambers than in the suction chamber facing the print zone and greater than in the upstream and downstream suction chambers.

6. The printer according to claim 3, wherein the transporter further comprises a drive for moving the belt in the first direction.

7. The printer according to claim 2, wherein in the inherently wrinkled medium print mode, the controller controls the print medium suction applicator to apply a negative pressure in suction chamber facing the print zone, so that a portion of the print medium is locally flattened and any pre-formed wrinkles in the portion are moved into a buffer zone wherein the suction reduction means have reduced or prevented suction.

8. The printer according to claim 1, wherein the print applicator further comprises a printhead carriage translatable in a second direction perpendicular to the first direction, wherein a trajectory of the printhead carriage defines the print zone.

9. The printer according to claim 1, wherein the transporter further comprises an input roller for supporting a roll of wound-up print medium.

10. The printer according to claim 9, wherein the transporter comprises the print medium suction applicator.

11. A method for printing on a wrinkled print medium, the method comprising:
transporting an inherently wrinkled print medium through a print zone facing a print applicator;
applying suction to the inherently wrinkled print medium in the print zone; and
preventing suction in at least one buffer zone adjacent to and upstream and/or downstream of the print zone, so that the inherently wrinkled print medium is locally flattened in the print zone, forcing pre-formed wrinkles into the at least one buffer zone.

12. The method according to claim 11, further comprising:
transporting a wrinkle-free print medium through the print zone;
applying suction to the wrinkle-free print medium in the print zone; and
applying suction in the at least one buffer zone, so that the wrinkle-free print medium is locally flattened in the print zone and the at least one buffer zone.

13. The method according to claim 12, wherein the step of transporting further comprises:
moving a belt, wherein suction is applied to the print medium via passages in the belt, and
applying greater suction to the print medium in at least one driving zone as compared to the print zone and the at least one buffer zone, wherein the at least one buffer zone is positioned between its adjacent driving zone and the print zone.

14. The method according to claim 12, wherein the step of applying greater pressure is applied in a driving zone upstream of the print zone and in another driving zone downstream of the print zone, and/or wherein the step of applying suction in the at least one buffer zone is applied a buffer zone upstream of the print zone and in another buffer zone downstream of the print zone.

15. The method according to claim 14, further comprising the step of applying suction to the buffer zone and the other buffer zone by means of a first suction source and/or applying suction to the driving zone and the other driving zone by means of a second suction source.

16. A printer comprising:
a print applicator comprising at least one printhead arranged to define a print zone, wherein the at least one printhead is configured to print on a portion of a print medium in the print zone;
a transporter configured to move the print medium through the print zone with respect to the print applicator in a first direction; and
a print medium suction applicator comprising a plurality of suction chambers,
wherein at least one suction chamber of the plurality of suction chambers faces the print zone, and
wherein at least one other suction chamber is arranged upstream and/or downstream of the at least one suction chamber facing the print zone in the first direction, and
wherein the print medium suction applicator comprises a suction reduction unit configured to selectively prevent or reduce suction in the at least one other suction chamber.

17. The printer according to claim 16, wherein the transporter comprises and endless belt, and wherein the print zone spans a substantially full width of the belt in a lateral direction perpendicular to the transport direction.

18. The printer according to claim 17, wherein the at least one other suction chamber is positioned outside of the print zone when viewed in a height direction perpendicular to the transport and lateral directions.

19. The printer according to claim 18, wherein the at least one suction chamber is positioned within the print zone when viewed in a height direction perpendicular to the transport and lateral directions.
